(19) United States
(12) Patent Application Publication
(10) Pub. No.: US 2015/0130177 A1
(43) Pub. Date: May 14, 2015

(54) Spiral Notebook Repair Strip

(71) Applicant: Barbara Becker, Kettering, OH (US)

(72) Inventor: Barbara Becker, Kettering, OH (US)

(21) Appl. No.: 14/078,741

(22) Filed: Nov. 13, 2013

(51) Int. Cl. B42B 5/12

(52) U.S. Cl. CPC B42B 5/12
USPC 281/38

(57) ABSTRACT

A spiral notebook repair strip includes a substrate having a first side and second side having a latent pressure sensitive adhesive (PSA) thereon. The substrate includes at least a pair of cut openings extending from an edge of the substrate inwardly and each terminate in a separate aperture for receiving a portion of a wire binder of the spiral notebook.

### BACKGROUND OF THE INVENTION

1. Field of Invention

The present invention relates to repairing torn pages and/or inserting and attaching documents and other items to a wire bound medium such as a spiral notebook or tablet.

2. Prior Art

Spiral wire bound notebooks are widely used by students, office workers, and record keepers. The spiral notebook provide a permanent record of the documents in an easy to use manner.

Two shortcomings of the spiral notebook are that the pages tend to tear from the wire in an unwanted manner and there is not a desirable way to insert new pages into such notebook. Currently, adhesive rings and other forms of individually adhesive members are used to secure about a single portion of the wire. These are relatively cumbersome if numerous tears exist in the sheet and do not provide an ideal fix to the torn sheet.

As to making insertions, the current prior art provides only for attaching a new sheet using a strip tab in connection with a separate sheet to which it can be attached and then subsequently inserted into the notebook. However, this does not provide a dual purpose device which not only provides for inserts but also provides for repair of torn pages.

There have been a variety of approaches to the problem of making inserts of wire bound media in the art. Some of these are illustrated in U.S. Pat. Nos. 443,001 and 4,193,704. While these patents share an objective of the present invention, they are designed differently and do not have the advantages of the instant invention. The fastener disclosed in U.S. Pat. No. 4,430,015 uses tabs positioned adjacently such that they form a notch which opens on and provides access to an aperture in which the wire binder is retained upon insertion of the fastening means into a notebook or similar wire bound medium. U.S. Pat. No. 4,193,704 is designed with structurally dissimilar tab and hook portions.

### SUMMARY OF THE INVENTION

It is an object to provide a convenient instrument for repairing or inserting pages into a spiral bound notebook or tablet.

It is another object to improve spiral notebooks and tablets.

Accordingly, these and other objects are accomplished with the present invention which provides a spiral notebook repair strip comprising a substrate having a first side and second side having a latent pressure sensitive adhesive (PSA) thereon. In one embodiment, the substrate includes at least a pair of cut openings extending from an edge of the substrate inwardly and terminate in a separate aperture for receiving a portion of a wire binder of the spiral notebook. The cut opening is slightly smaller than the wire outer diameter (O.D.) of the spiral notebook.

In another embodiment, the strip is less width than an inner diameter formed by spiral rings of a spiral notebook. In this way, the strip is inserted into and through the spiral wire ring and laid over the page edge to be repaired.

The spiral notebook repair strip of the present invention can be attached to the torn document by connecting the strip to the wire opposite the page to be connected, and with the latent PSA activated for connection to the torn edge of the page.

### BRIEF DESCRIPTION OF THE DRAWINGS

The present invention is described in more detail below by reference to the accompanying drawings wherein:

FIG. 1 is a plan view of a spiral notebook repair strip in accordance with the present invention;

FIG. 2 is a perspective view of the spiral notebook repair strip of the invention.

FIG. 3 illustrates an application step of the invention in connecting to a spiral notebook.

FIG. 4 shows a second application step in connecting the spiral notebook repair strip to an opposing torn page.

FIG. 5A shows yet an embodiment wherein the spiral notebook repair strip is attached to a sheet the spiral notebook.

FIG. 5B shows another embodiment wherein the spiral notebook repair strip having a tab is attached to a sheet the spiral notebook.

FIG. 6 shows a plurality of spiral notebook repair strips connected in a perforated manner in a form of a sheet fed stock.

FIG. 7 shows still another embodiment wherein the spiral notebook repair strip having a tab is attached to a sheet the spiral notebook.

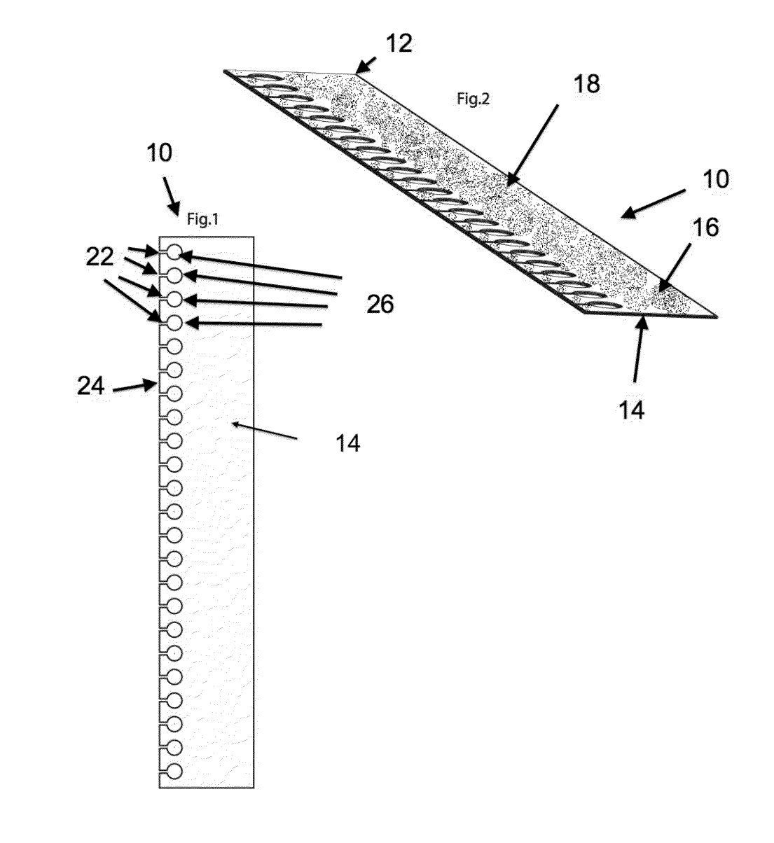

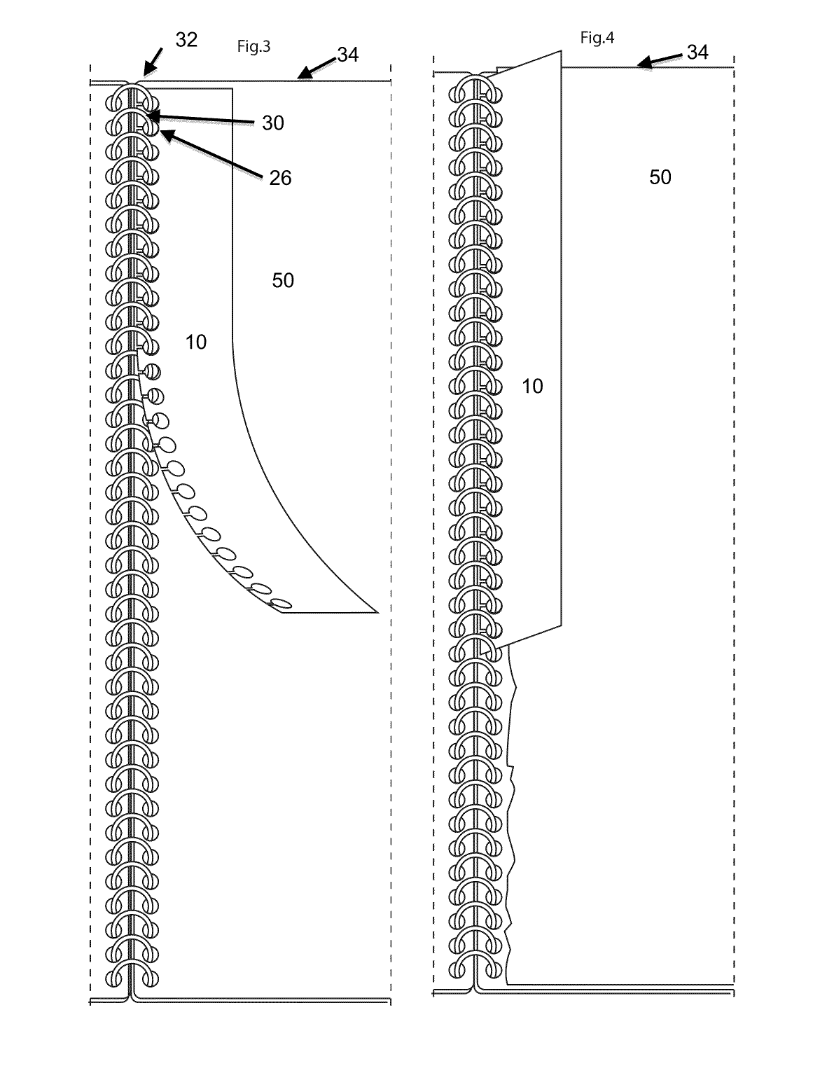

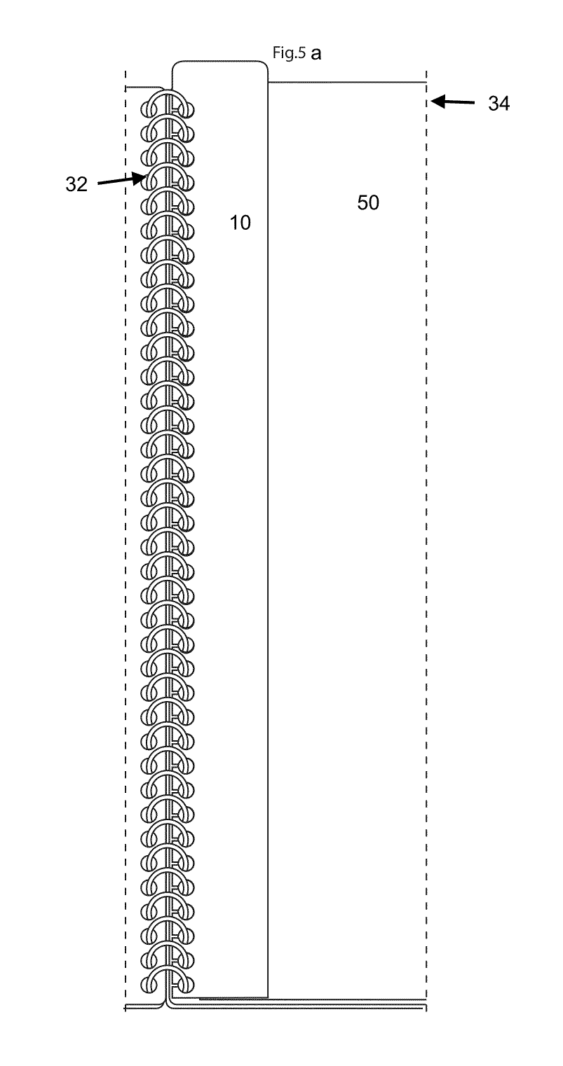

### DETAILED DESCRIPTION OF THE INVENTION

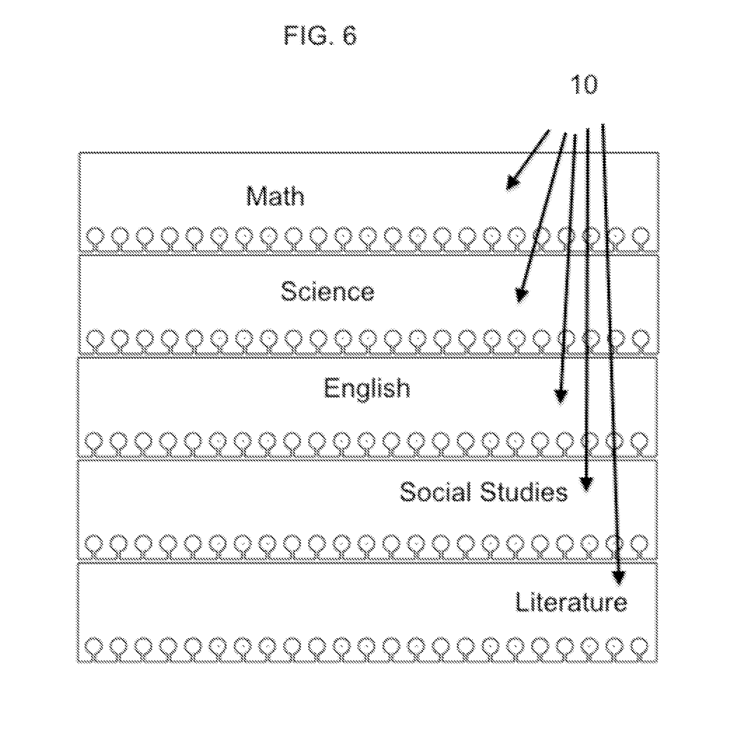

Referring now to the drawings, the spiral notebook repair strip of the present invention is generally designated by the numeral 10. The spiral notebook repair strip 10 preferably includes a relatively rigid substrate 12 which can be elongated or formed in sheet form wherein strips 10 are connected with perforations to enable separation thereof as seen in FIG. 6. The substrate 12 has a first side 14 and second side 16. Preferably, a latent pressure sensitive adhesive (PSA) 18 can be applied to the second side 16. The latent PSA or latent adhesive is masked by chemical means, for example, such that is can be coated or sprayed on manner and when in a dry state is not exposed as tacky until activated for use. This enables the strip 10 to be easily inserted into a desired location and once positioned in a desired position, the latent PSA 18 can be activated. Activation can occur by means such as heat or pressure to cause the PSA 18 to become exposed or other activating source. This is advantageous as it can provide a surface side 14, for example, to be printed on as seen in FIG. 6, as it is run through a printer which can also render the latent PSA 18 activate.

In one embodiment, the substrate 12 can include at least a pair, and preferably a plurality, of cut openings 22 to extending from an edge 24 of the substrate 12 inwardly and terminate each in a separate aperture 26 for receiving a portion 30 of a binder wire 32 of spiral notebook 34. The strip 10 can have up to a number of cut openings 22 and apertures 26 sufficient to equal the number of rings 36 on the spiral notebook 34. The cut openings 22 are slightly smaller than the portion 34 of wire 32 outer diameter (O.D.) of the spiral notebook 34.

The apertures 26 can be circular and approximately the same diameter as the holes in the edge of sheet 50 bound in spiral notebook 34. Opening 22 may range in size from only a slit between adjacent tabs to a size slightly less than the outer diameter of the wire. Once spiral notebook repair strip 10 is attached to the wire 32, the spiral notebook repair strip 10 and sheet/article to which it is attached is prevented from inadvertent removal from the notebook 34 by the stresses encountered in normal handling. It is contemplated that the strip 10 can be of a length of a sheet 50 of the notebook 34 or only part way which provides a minimum of a plurality of apertures 26 for retaining the wire 32.

For attaching the strip 10 to the sheet or item to be inserted, the strip 10 can be inserted into the notebook 34 such that the second side 16 is opposing the sheet/item 50 to which it is to be connected. The strip 10 and sheet 50 can be mated by flipping one onto the other. Heat or other activating source triggers the PSA adhesive 18 to connect the two.

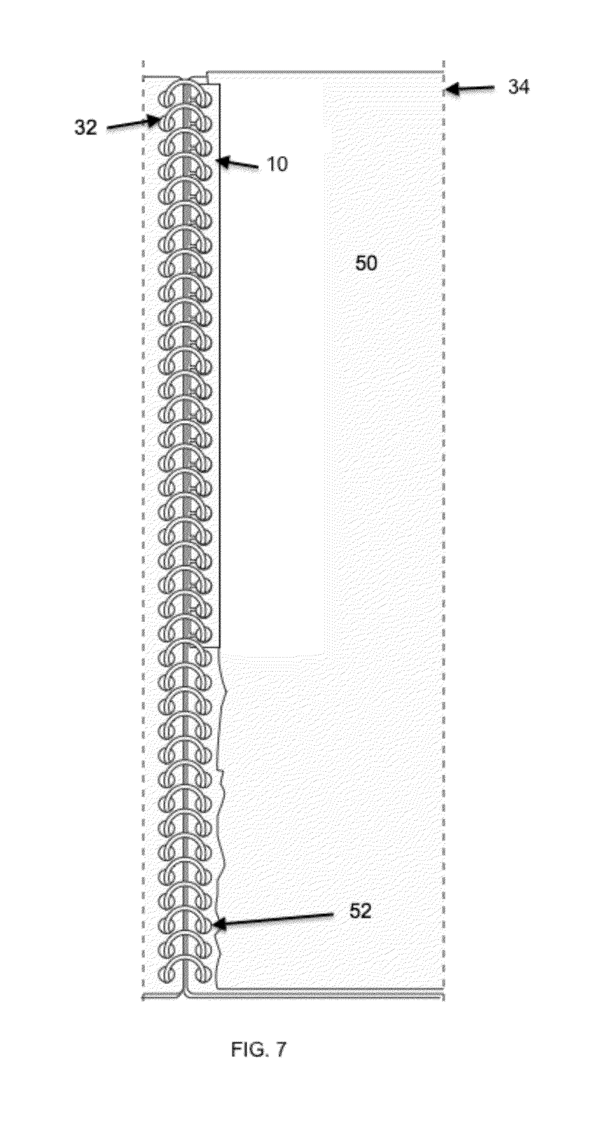

In another embodiment shown in FIG. 7, the strip 10 can be of a width smaller than an inner diameter opening formed wire 32 and of a length to extend from an upper edge of sheet 50 to at least an opening 52 of the sheet 50 and could extend an entire length of sheet 50. Insertion of the strip 10 is through the wire 32 and once so positioned, is activated for connection. In this way, the strip 10 is able to be positioned to a desired position without adhering to the sheet 50 until properly positioned.

The strip 10 can be made of tagboard or relatively rigid plastic and thus enable insertion and removal of the strip 10 from the notebook 34 as desired. Thus, the strip 10 is formed of a material which resists stretching and tearing such as heavier weight papers or card stock but may be less resistant to tearing than plastics and other available polymers. Accordingly, a feature and benefit of the latent PSA 18 is that the rigid strip 10 can be easily moved along the surface of the sheet 50 to a desired position for affixation.

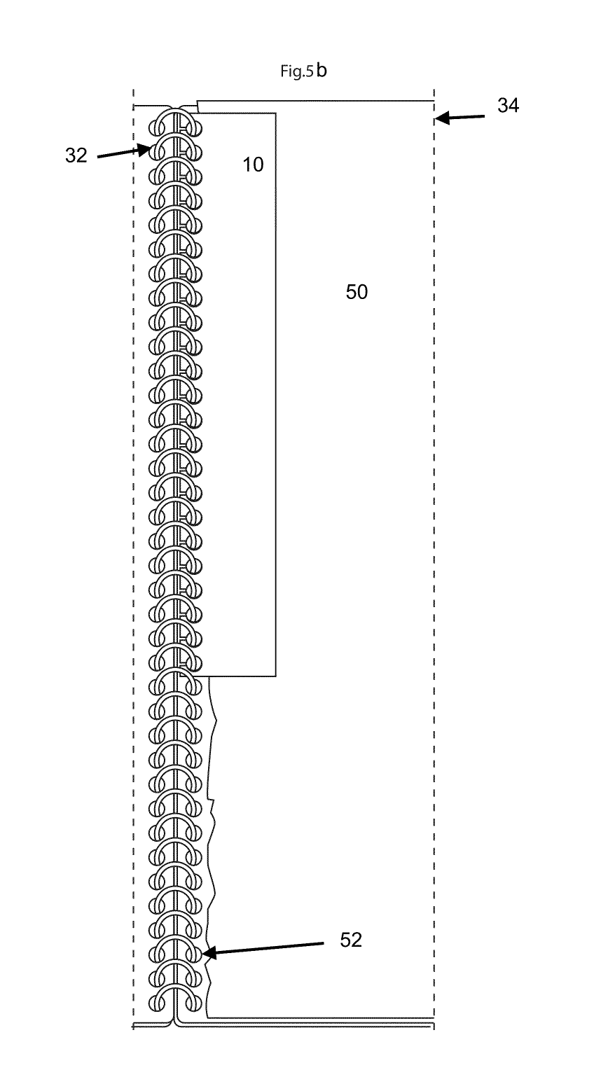

Depending on the embodiment, the strip 10 can be generally from about 1/8th inch to an inch wide. Page inserts, dividers and the like may be supplied with the strip 10 of the present invention as shown in FIG. 5B.

While the present invention has been explained by reference to a spiral wire binder, it will be readily apparent to those skilled in the art that its teachings are equally applicable to other wire binders. In particular, with appropriate modifications, the strip of the present invention may be used in conjunction with a double wired cylindrical binder. Having described the invention in detail and by reference to specific embodiments thereof, it will be apparent that numerous variations and modifications therein are possible without departing from the invention defined in the following claims.

1. A spiral notebook repair strip, comprising:
a substrate having a first side and second side having a latent pressure sensitive adhesive thereon, said substrate includes at least a pair of cut openings extending from an edge of the substrate inwardly and each terminates in a separate aperture for receiving a portion of a wire binder of the spiral notebook.

2. The spiral notebook repair strip of claim 1, wherein said cut opening is slightly smaller than an outer diameter of a portion of the wire of the spiral notebook.

3. The spiral notebook repair strip of claim 1, wherein said strip is between about ⅛th and 1 inch width.

4. The spiral notebook repair strip of claim 1, wherein said strip includes a tab portion which when said strip is connected to the spiral notebook, said tab extends outside the notebook.

5. A spiral notebook repair strip, comprising:
a substrate having a first side and second side having a latent pressure sensitive adhesive thereon, said substrate strip is less width than an inner diameter formed by spiral rings formed by a wire of a spiral notebook.

6. The spiral notebook repair strip of claim 5, wherein said strip is between about ⅛th and ¼ inch width.

7. The spiral notebook repair strip of claim 5, wherein said strip includes a tab portion which when said strip is connected to the spiral notebook, said tab extends outside the notebook.
